(19) United States
(12) Patent Application Publication
(10) Pub. No.: US 2024/0331520 A1
(43) Pub. Date: Oct. 3, 2024

(54) EMERGENCY ALERT SYSTEM

(71) Applicant: LEEB Innovaions, LLC, West Warwick, RI (US)

(72) Inventor: Leveland BROWN, West Warwick, RI (US)

(21) Appl. No.: 18/127,837

(22) Filed: Mar. 29, 2023

(51) Int. Cl. G08B 21/02; G08B 31/00; H04W 4/021; H04W 4/024; H04W 4/029; H04W 4/90

(52) U.S. Cl. CPC G08B 21/02; G08B 31/00; H04W 4/021; H04W 4/024; H04W 4/029; H04W 4/90

(57) ABSTRACT

A computer implemented method includes providing a first user interface, a second user interface, and a third user interface comprising threat identifiers associated with a geographical zone, and receiving by way of the first user interface a signal indicative at least one of the first, second, or third user is in danger. The method includes alerting, by way of the second user interface and the third user interface, the second user and the third user of the signal indicative the at least one of the first, second, or third user is in danger, wherein the alerting comprises non-audible signals. The method includes alerting a fourth user interface of the signal indicative at least one of the first user, the second user, or the third user is in danger, wherein the alerting the fourth user interface comprises identifying the first, second, and third GPS locations.

### FIELD

This invention is related to methods for improving safety. Specifically, but not intended to limit the invention, embodiments of the invention are related to safety systems and methods for improving the safety of multiple persons.

### BACKGROUND

It is no secret that mass shootings in public spaces such as schools, shopping malls, or theaters are on the rise in the United States. Moreover, ownership of high-powered weapons is unlikely to be restricted, but instead expanded with, among other things, the rise of ghost guns. Today, school facilities attempt to protect students through the use of metal scanners or backpack searches during entry, school shooter drills, locking doors, and the employment of school resource officers. Such efforts appear to provide little benefit to student safety. More directly, educators in most states are trained to “hunker down” with children in their classrooms, with little to no guidance beyond that. Unfortunately, most active shooters have undergone, while in school themselves, the same active shooter drills that continue to be executed today and therefore are aware of where students and teachers are likely to hide. As for employees in shopping malls and large business facilities, there is little emphasis on training for protection from mass or active shooters. There therefore remains a need for a new approach to protecting large groups of people in an employment or educational setting.

### SUMMARY

An exemplary computer implemented method includes providing a first user interface to a first person comprising a threat identifier associated with a geographical zone; providing a second user interface to a second person comprising a threat identifier associated with the geographical zone; and providing a third user interface to a third person comprising a threat identifier associated with the geographical zone. The exemplary method includes receiving by way of the first user interface a signal indicative at least one of the first, second, or third user is in danger; and alerting, by way of the second user interface and the third user interface, the second user and the third user of the signal indicative the at least one of the first, second, or third user is in danger, wherein the alerting comprises non-audible signals. The exemplary method includes identifying a first GPS location of the first user interface; identifying a second GPS location of the second user interface; and identifying a third GPS location of the third user interface. The exemplary method includes alerting a fourth user interface of the signal indicative at least one of the first user, the second user, or the third user is in danger, wherein the alerting the fourth user interface comprises identifying the first, second, and third GPS locations.

An exemplary system includes at least one non-transitory computer-readable medium with instructions encoded thereon, and one or more processors configured to, when executing the instructions, perform operations associated with the method in the preceding paragraph.

An exemplary emergency alert system includes a first wearable device associated with a first user, the first wearable device comprising a mechanism to attach the first wearable device to the first person, a second wearable device associated with a second user, the second wearable device comprising a mechanism to attach the second wearable device to the second person, and a third wearable device associated with a third user, the third wearable device comprising a mechanism to attach the third wearable device to the third person. The alert system includes at least one non-transitory computer-readable medium with instructions encoded thereon, and one or more processors configured to, when executing the instructions, perform operations associated with the method in paragraph 004.

### BRIEF DESCRIPTION ON THE DRAWINGS

FIG. 1 is a schematic of an exemplary emergency alert system;

FIG. 2 is a flowchart of an exemplary method; and

FIG. 3 is a schematic of an exemplary system.

### DETAILED DESCRIPTION

Before turning to the details of the invention, it is expedient to describe general inventive concepts associated therewith. First, there remains a need to improve the safety of persons in a group setting in which it is difficult to prevent with accuracy dangerous persons such as active shooters from encroaching. To solve this problem, Applicant has devised a system for the protected persons to communicate with one another and/or law enforcement without drawing attention of the communications to the dangerous persons. For the purpose of this document, the terms “user interface” and “device” may be used interchangeably.

The system 100 and devices described herein may be particularly suited for use by teachers, college students, elderly, department store employees, state employees, and/or government officials.

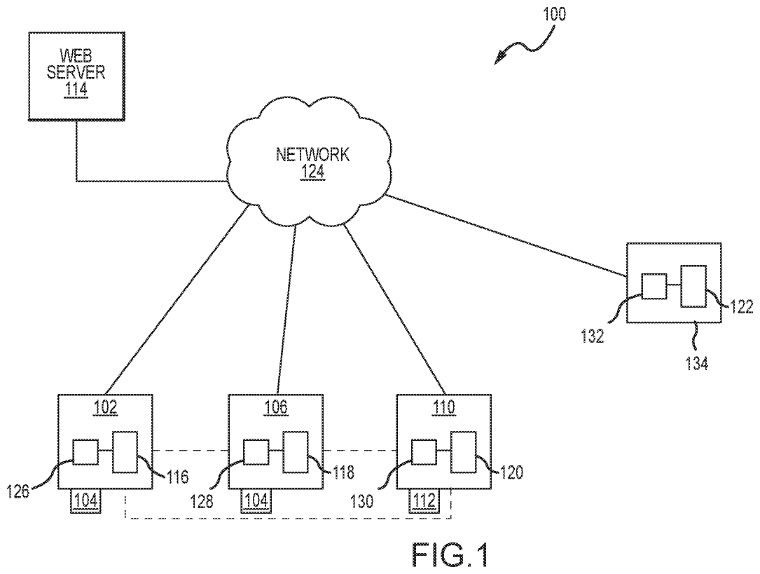

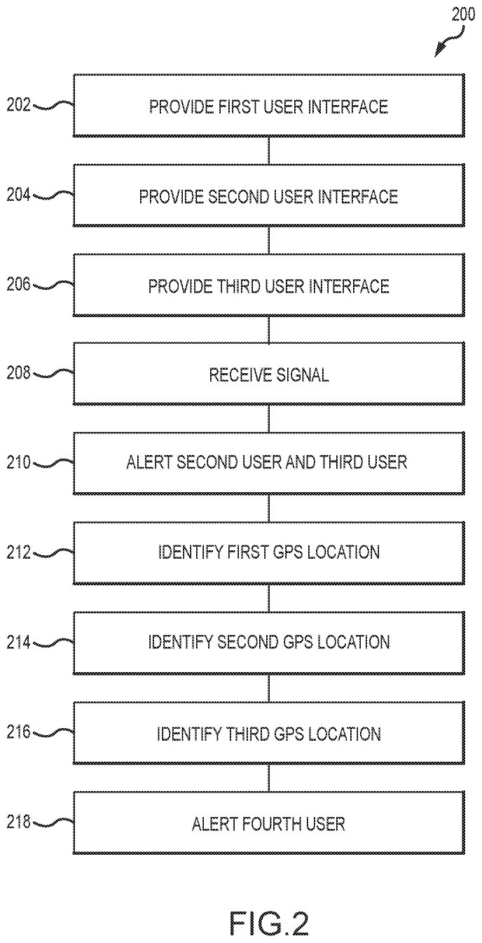

Turning now to FIG. 1 and FIG. 2, an emergency alert system 100 or alert system 100 is described herein. The alert system 100 may be used by, for example, education professionals. A plurality of education professionals may wear a plurality of devices on their persons. The devices may be, for example, bracelets or necklaces having user interfaces, GPS location means, and wireless communication means. The user interfaces may include buttons to allow the users to input a signal and lights to alert the users. For example, the lights may be generally set to ‘green’ associated with a safe situation and changing to ‘red’ to alert to danger.

The alert system 100 may include a first wearable device 102 associated with a first user. The first wearable device 102 may have a mechanism 104 to attach the first wearable device 102 to the first person. The mechanism 104 for attachment may include a bracelet, lock, neckless, or any other suitable attachment mechanism for temporarily attaching the first wearable device 102 to the first person. The mechanism 104 may be configured to attach the first wearable device 102 in a manner that is discrete. The device 102 may include ornamental features that disguise the device 102 so as to not draw attention from a dangerous person.

The alert system 100 may include a second wearable device 106 associated with a second user. The second wearable device 106 may have a mechanism 108 to attach the second wearable device 106 to the second person. The mechanism 108 for attachment may include a bracelet, lock, neckless, or any other suitable attachment mechanism for temporarily attaching the second wearable device 106 to the second person. The mechanism 108 may be configured to attach the second wearable device 106 in a manner that is discrete. The device 106 may include ornamental features that disguise the device 106 so as to not draw attention from a dangerous person.

The alert system 100 may include a third wearable device 110 associated with a third user. The third wearable device 110 may have a mechanism 112 to attach the third wearable device 110 to the third person. The mechanism 112 for attachment may include a bracelet, lock, neckless, or any other suitable attachment mechanism for temporarily attaching the third wearable device 110 to the third person. The mechanism 112 may be configured to attach the third wearable device 110 in a manner that is discrete. The device 110 may include ornamental features that disguise the device 110 so as to not draw attention from a dangerous person.

As an example, the first wearable device 102 may be a bracelet with a button (e.g. user interface 126) on it so that when the user pushes the button, the device 102 wirelessly communicates information to the third device 134, which may be a security guard computing system. The information may include the first user's identification, location, and/or picture. In some embodiments, when the first user pushes the button, the first wearable device 102 may begin a sound and/or visual recording. For example, the device 102 may automatically record for two minutes, in response to the pressing of the button, thus giving the user the opportunity to record information about the specific threat (e.g. a description of a dangerous person and/or the person's movements, an environmental threat, or other), which can be shared with the third device 134 and/or the second device 104.

In some embodiments, devices 102, 104 are configured to be uniquely associated with particular users. For example, devices 102, 104 may be configured with passwords and/or physical locks that allow only a single user access. The devices 102, 104 may be battery powered. The devices 102, 104 may be rechargeable.

The alert system 100 may include at least one non-transitory computer-readable medium 114, 116, 118 120, 122, 124 with instructions encoded thereon and one or more processors configured to, when executing the instructions, perform operations.

The operations may include executing a method such as the method 200 illustrated in FIG. 2. The method 200 may include providing 202 a first user interface 126 to the first person comprising a threat identifier associated with a geographical zone. The geographical zone may include an area associated with a building, such as school grounds, a shopping mall, or a business facility.

The method 200 may include providing 204 a second user interface 128 to the second person comprising a threat identifier associated with the geographical zone.

The method 200 may include providing 206 a third user interface to 130 the third person comprising a threat identifier associated with the geographical zone.

The method 200 may include identifying 212 a first GPS location of the first device 102 and/or the first user interface 126.

The method 200 may include identifying 214 a second GPS location of the second device 104 and/or the second user interface 128.

The method 200 may include identifying 216 a third GPS location of the third device 106 and/or the third user interface 130.

The method 200 may include receiving 208 by way of the user interface 126, 128, 130 a signal indicative the first user or another user is in danger. For example, if the first user is an educator who realizes an active shooting is imminent, the first user may press a button to indicate the immediate area around the first user, such as a classroom, is in imminent danger. Or, for example, if the first user is a principal who sees an active shooter entering a building, the first user can silently indicate the users in that area are in imminent danger, and all users may be notified. This approach allows educators in different areas to respond appropriately in different ways, such as by exiting if safe, or “hunkering down” if too close.

The method 200 may include alerting 210, by way of the second user interface 128 and the third user interface 130, the second user and the third user of the signal indicative at least one of the first user, the second user, or the third user is in danger, wherein the alerting 210 comprises non-audible signals. For example, the second and third devices may show a map in which an area associated with the first GPS location is lit red. The second and third users thereby are made aware to avoid the first GPS location—and, specifically to know to direct children away from the first GPS location.

The method 200 may include alerting 218 a fourth user device 134 of the signal indicative at least one of the first user, the second user, or the third user is in danger, wherein the alerting the fourth user interface comprises identifying the first, second, and third GPS locations. For example, law enforcement may be alerted through wireless communications of the danger. Law enforcement may receive a telephone call identifying the danger and GPS locations, or the method 200 may include calculating a physical address for alerting authorities. In some embodiments, law enforcement may be included on a peer-to-peer network for such communications.

The method 200 may include calculating by applying a predictive computer model, a future threat level to the second user or the second user interface and a future threat level to the third user or the third user interface. The method 200 may include alerting the fourth user interface 132 or fourth user of at least one of the future threat level to the second user interface 128 or second user or the future threat level to the third user interface 130 or third user. For example, the predictive model may determine that an active shooter is in, say, a cafeteria directly next to classroom A and a gym, while a classroom B is on the other side of the geographic zone. The predictive computer model may establish that persons located in classroom A and the gym are in imminent danger, while those in classroom B are in less imminent danger.

The method 200 may include calculating the likelihood of at least another one of the users being in danger in the future.

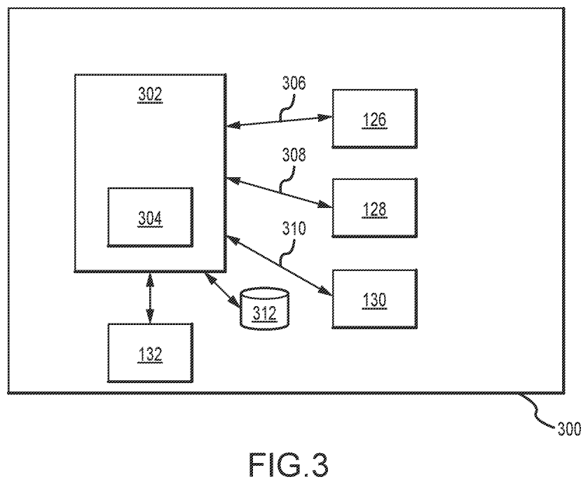

The method 200 may include storing at least one escape route associated with the geographical zone. Users may be notified if they are in the ‘imminent danger’ zone by way of red lights or the ‘less imminent danger’ zone by way of yellow lights. Users in the ‘less imminent danger’ zone may be alerted to suitable escape routes by way of green or yellow lights, so they can evacuate children while the active shooter is on the other side of the school. In some embodiments, the method 200 may include storing a map of a building in the geographical zone. One or more lights may be associated with each room of the building, so as to identify which rooms are in safe, in imminent danger, or in less imminent danger. Storing may be accomplished by, for example, the data store 312 illustrated in FIG. 3.

The method 200 may include receiving an instruction from the fourth user interface 132 or user or fourth device 134 on at least one of the first, second, or third user interface 126, 128, 130 or devices 102, 106, 110. The instruction may include an instruction to at least one of move to a different location, move toward or through the at least one escape route, remain in place, open a window, open a door, close a window, or close a door. Users in ‘imminent danger’ and ‘less imminent danger’ zones may receive instructions from law enforcement that differ. For example, those in the ‘imminent danger’ zone may receive instructions to seek protective cover, lock doors, and hide as best as possible, while those in ‘less imminent danger’ zones may be instructed to silently evacuate. It is stressed here that children today are regularly exposed to news of active shooters and are well trained to remain silent during active shooter drills.

The method 200 may include causing, responsive to a user input, a sound recording and/or video recording on at least one of the first, second, or third devices 102, 106, 110. The recording may include recording a user's description of the danger such as the dangerous person. The method 200 may include transmitting the recording to at least one of the other users and/or a law enforcement device 134. The transmitting may be executed automatically in some embodiments without the need for the associated user to instruct the respective user's device to transmit. The transmitting may be executed automatically upon a determining that at least one user device 102, 106, 110 in the geographical zone has initiated an alert of danger.

As an example, method 200 may include a device 102, 104, which may be a bracelet, wirelessly communicating information to a device 134, which may be a security guard computing system. The information may include the first user's identification, location, and/or picture. In some embodiments, the method 200 may include, on the first wearable device 102, generating a sound and/or visual recording. For example, the device 102 may automatically record for two minutes, in response to an action by the first user, thus giving the first user the opportunity to record information about the specific threat (e.g. a description of a dangerous person and/or the person's movements, an environmental threat, or other), which can be shared with the third device 134 and/or the second device 104. The method 200 may include transmitting a sound recording from the first device 102 to the third device 134. The method 200 may include transmitting a visual recording from the first device 102 to the third device. The method 200 may include transmitting a sound and/or visual recording from the first device 102 to the second device 104 and the third device 134.

In some embodiments, the method 200 may include authenticating a user associated with a device 102, 104.

In some embodiments, the devices 102, 106, 110 may wirelessly communicate directly with each other through, for example, a peer-to-peer network as shown by the dashed lines and/or through a web-based network 124. The devices may be monitored and/or controlled by a web server 114.

In some embodiments, the devices 102, 106, 110 may communicate with the device 134 by way of a wireless network 124. The device 134 may be associated with law enforcement personnel or security staff. For example, security staff in a school or shopping facility may be in communication with users 102, 106, 110 via a peer-to-peer network, a cloud network, or other wireless communication means. The communication means may be encrypted.

Turning now to FIG. 3, a system 300 is described.

The system 300 may include at least one non-transitory computer-readable medium 302 with instructions encoded thereon, and one or more processors 304 configured to, when executing the instructions, perform operations of: providing a first user interface 126 to a first person comprising a threat identifier associated with a geographical zone; providing a second user interface 128 to a second person comprising a threat identifier associated with the geographical zone; and providing a third user interface 130 to a third person comprising a threat identifier associated with the geographical zone.

The operations may include receiving by way of the first user interface a signal across signal mechanism 306 indicative at least one of the first user, the second user, or the third user is in danger. The signal mechanism 306 may be a wireless communication such as that known in the art.

The operations may include alerting, by way of the second user interface 128 and the third user interface 130 the second user and the third user of the signal indicative at least one of the first user, the second user, or the third user is in danger, wherein the alerting comprises non-audible signals. The alerting may be performed by emitting a wireless signal to cause one or more user interfaces 126, 128, 130 to provide a non-audible signal. For example, the alerting may cause one or more interfaces to light a red light, a green light, or other. The alerting may occur through the use of wireless communication mechanism 306, 308, 310. The alerting may include alerting law enforcement devices 132.

The system 300 may be configured to execute any steps associated with method 200 or performed by the system 100 described in FIG. 1

A computer implemented method may include any steps described in association with method 200 or performed by the system 100 in FIG. 1 and/or the system 300 described in FIG. 3.

As a practical matter, the alert system 100, method 200, system 300, and the computer implemented method may be implemented as follows.

All educators in a building may be issued bracelets or necklaces that they wear while on school grounds. Although the examples described herein have focused on active shooter on school grounds scenarios, the methods and systems described herein are equally suited to businesses, such as large warehouses, public employees, and more.

Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms-even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, the disclosure of a “communication mechanism” should be understood to encompass disclosure of the act of “communicating”—whether explicitly discussed or not—and, conversely, were there only disclosure of the act of “communicating”, such a disclosure should be understood to encompass disclosure of a “communicating mechanism”. Such changes and alternative terms are to be understood to be explicitly included in the description.

Moreover, the claims shall be construed such that a claim that recites “at least one of A, B, or C” shall read on a device that requires “A” only. The claim shall also read on a device that requires “B” only. The claim shall also read on a device that requires “C” only.

Similarly, the claim shall also read on a device that requires “A+B”. The claim shall also read on a device that requires “A+B+C”, and so forth.

Those skilled in the art can readily recognize that numerous variations and substitutions may be made in the invention, its use and its configuration to achieve substantially the same results as achieved by the embodiments described herein.

Accordingly, there is no intention to limit the invention to the disclosed exemplary forms. Many variations, modifications and alternative constructions fall within the scope and spirit of the invention as expressed in the claims.

What is claimed is:

1. A computer implemented method, comprising:
providing a first user interface to a first person comprising a threat identifier associated with a geographical zone;
providing a second user interface to a second person comprising a threat identifier associated with the geographical zone;
providing a third user interface to a third person comprising a threat identifier associated with the geographical zone;
receiving by way of the first user interface a signal indicative at least one of the first, second, or third user is in danger;
alerting, by way of the second user interface and the third user interface, the second user and the third user of the signal indicative the at least one of the first, second, or third user is in danger, wherein the alerting comprises non-audible signals;
identifying a first GPS location of the first user interface;
identifying a second GPS location of the second user interface;
identifying a third GPS location of the third user interface; and
alerting a fourth user interface of the signal indicative at least one of the first user, the second user, or the third user is in danger, wherein the alerting the fourth user interface comprises identifying the first, second, and third GPS locations.

2. The method of claim 1, comprising:
calculating, by applying a predictive computer model, a future threat level to the second user interface and a future threat level to the third user interface.

3. The method of claim 2, comprising:
alerting the fourth user interface of at least one of the future threat level to the second user interface or the future threat level to the third user interface.

4. The method of claim 2, comprising:
calculating the likelihood of at least another one of the first, second, or third users being in danger in the future.

5. The method of claim 1, comprising:
receiving an instruction from the fourth user interface on at least one of the first, second, or third user interface.

6. The method of claim 5, wherein:
the instruction comprises an instruction to at least one of move to a different location, remain in place, open a window, open a door, close a window, or close a door.

7. The method of claim 1, comprising:
storing at least one escape route associated with the geographical zone.

8. The method of claim 7, comprising:
receiving an instruction from the fourth user interface on at least one of the first, second, or third user interface; wherein
the instruction comprises an instruction to move through or toward the at least one escape route.

9. The method of claim 1, comprising:
causing, responsive to a user input, at least one of a sound recording or a video recording on at least one of the first, second, or third user interfaces; and
transmitting the at least one of the sound recording or video recording to another one of the first, second or third user interfaces.

10. A system, comprising:
at least one non-transitory computer-readable medium with instructions encoded thereon;
one or more processors configured to, when executing the instructions, perform operations of:
providing a first user interface to a first person comprising a threat identifier associated with a geographical zone;
providing a second user interface to a second person comprising a threat identifier associated with the geographical zone;
providing a third user interface to a third person comprising a threat identifier associated with the geographical zone;
receiving by way of the first user interface a signal indicative at least one of the first user, the second user, or the third user is in danger;
alerting, by way of the second user interface and the third user interface, the second user and the third user of the signal indicative the at least one of the first user, second user, or third user is in danger, wherein the alerting comprises non-audible signals;
identifying a first GPS location of the first user interface;
identifying a second GPS location of the second user interface;
identifying a third GPS location of the third user interface; and
alerting a fourth user interface of the signal indicative the at least one of the first user, the second user, or the third user is in danger, wherein the alerting the fourth user interface comprises identifying the first, second, and third GPS locations.

11. The system of claim 10, wherein:
the one or more processors are configured to, when executing the instructions, calculate,
by applying a predictive computer model, a future threat level to the other users; and
alert the fourth user interface of at least one of the future threat level to the other users.

12. The system of claim 11, wherein:
the one or more processors are configured to, when executing the instructions, calculate the likelihood of at least another one of the users being in danger in the future.

13. The system of claim 10, wherein:
the one or more processors are configured to, when executing the instructions, receive an instruction from the fourth user interface on at least one of the first, second, or third user interface.

14. The system of claim 13, wherein:
the instruction comprises an instruction to at least one of move to a different location, remain in place, open a window, open a door, close a window, or close a door.

15. The system of claim 10, wherein:
the one or more processors are configured to, when executing the instructions, store at least one escape route associated with the geographical zone.

16. An emergency alert system, comprising:
a first wearable device associated with a first user, the first wearable device comprising a mechanism to attach the first wearable device to the first person;
a second wearable device associated with a second user, the second wearable device comprising a mechanism to attach the second wearable device to the second person;
a third wearable device associated with a third user, the third wearable device comprising a mechanism to attach the third wearable device to the third person;
at least one non-transitory computer-readable medium with instructions encoded thereon;
one or more processors configured to, when executing the instructions, perform operations of:
providing a first user interface to the first person comprising a threat identifier associated with a geographical zone;
providing a second user interface to the second person comprising a threat identifier associated with the geographical zone;
providing a third user interface to the third person comprising a threat identifier associated with the geographical zone;
receiving by way of the first user interface a signal indicative at least one of the first user, second user, or third user is in danger;
alerting, by way of the second user interface and the third user interface, the second user and the third user of the signal, wherein the alerting comprises non-audible signals;
identifying a first GPS location of the first user interface;
identifying a second GPS location of the second user interface;
identifying a third GPS location of the third user interface; and
alerting a fourth user interface of the signal indicative the at least one of the first user, second user, or third user is in danger, wherein the alerting the fourth user interface comprises identifying the first, second, and third GPS locations.

17. The emergency alert system of claim 16, wherein:
the one or more processors are configured to, when executing the instructions,
calculate, by applying a predictive computer model, a future threat level to the other users; and
alert the fourth user interface of at least one of the future threat level to the other users.

18. The emergency alert system of claim 16, wherein:
the one or more processors are configured to, when executing the instructions, calculate the likelihood of at another one of the users being in danger in the future.

19. The emergency alert system of claim 16, wherein:
the one or more processors are configured to, when executing the instructions, store at least one escape route associated with the geographical zone; and
receive an instruction from the fourth user interface on at least one of the first, second, or third user interface; wherein
the instruction comprises an instruction to at least one of move to a different location, move toward or through the at least one escape route, remain in place, open a window, open a door, close a window, or close a door.

20. The emergency alert system of claim 16, wherein:
the one or more processors are configured to, when executing the instructions, store at least one escape route associated with the geographical zone.
